(19) United States
(12) Patent Application Publication
(10) Pub. No.: US 2005/0108065 A1
(43) Pub. Date: May 19, 2005

(54) Method and system of estimating vehicle damage

(76) Inventor: Walter A. Dorfstatter, West Bloomfield, MI (US)

Correspondence Address: ANTHONY LUKE SIMON;General Motors Corporation, Legal Staff, Mail Code 482-C23-B21, P.O. Box 300, Detroit, MI, 48265-3000, US

(21) Appl. No.: 10/715,633

(22) Filed: Nov. 18, 2003

(51) Int. Cl. G06F 17/60

(52) U.S. Cl. 705/4

(57) ABSTRACT

A method for estimating vehicle damage comprising the steps of: sensing a vehicle incident; automatically sending vehicle incident data to a service center; using the incident data to automatically estimate a vehicle damage; and utilizing the estimated vehicle damage in a vehicle insurance decision process.

### TECHNICAL FIELD

This invention relates to a method and system of estimating vehicle damage.

### BACKGROUND OF THE INVENTION

It is known to measure the severity of an automotive vehicle impact. One known measurement is delta velocity, which is determined through various techniques and to which it has been proposed to add various types of other information and measurements. Delta velocity and, in some examples, other measurements are utilized for SIR deployment decisions by vehicle on-board computers and are used for notification systems alerting response persons to potential injury severity. Notification systems may utilize telematics services as the means for communicating to response persons.

Measurements such as delta velocity have also been utilized by incident investigators in investigating and analyzing the incident.

### SUMMARY OF THE INVENTION

Advantageously, this invention provides a method of estimating vehicle damage according to claim 1.

Advantageously, this invention provides a method and system that takes advantage of available information from vehicle sensors to automatically estimate vehicle damage and consider the automatic estimate in connection with the vehicle insurance process.

Advantageously, according to a preferred example, this invention provides a method and system allowing vehicle insurers to automatically verify damage estimates without utilizing insurance inspectors. Advantageously, then, this invention provides a tool by which vehicle insurance companies can save time and, therefore, money.

Advantageously, according to a preferred example, this invention provides a method and system allowing vehicle insurers to automatically make decisions regarding processing of vehicle insurance claims.

Advantageously, according to a preferred example, this invention provides a method comprising the steps of: sensing a vehicle incident, automatically sending vehicle incident data to a service center, using the incident data to automatically estimate a vehicle damage, and utilizing the estimated vehicle damage in a vehicle insurance decision process.

Advantageously, according to another preferred example, this invention provides a system comprising: a module sensing an occurrence of a vehicle incident and developing incident data responsive thereto, an in-vehicle transceiver for automatically sending vehicle incident data to a service center, an estimator within the service center using the incident data to automatically estimate a vehicle damage value, and a decision processor providing a business recommendation responsive to the estimated vehicle damage value.

### BRIEF DESCRIPTION OF THE DRAWINGS

FIG. 1 illustrates an example system for implementing this invention; and

FIGS. 2 and 3 illustrate example process steps according to this invention.

### DESCRIPTION OF THE PREFERRED EMBODIMENT

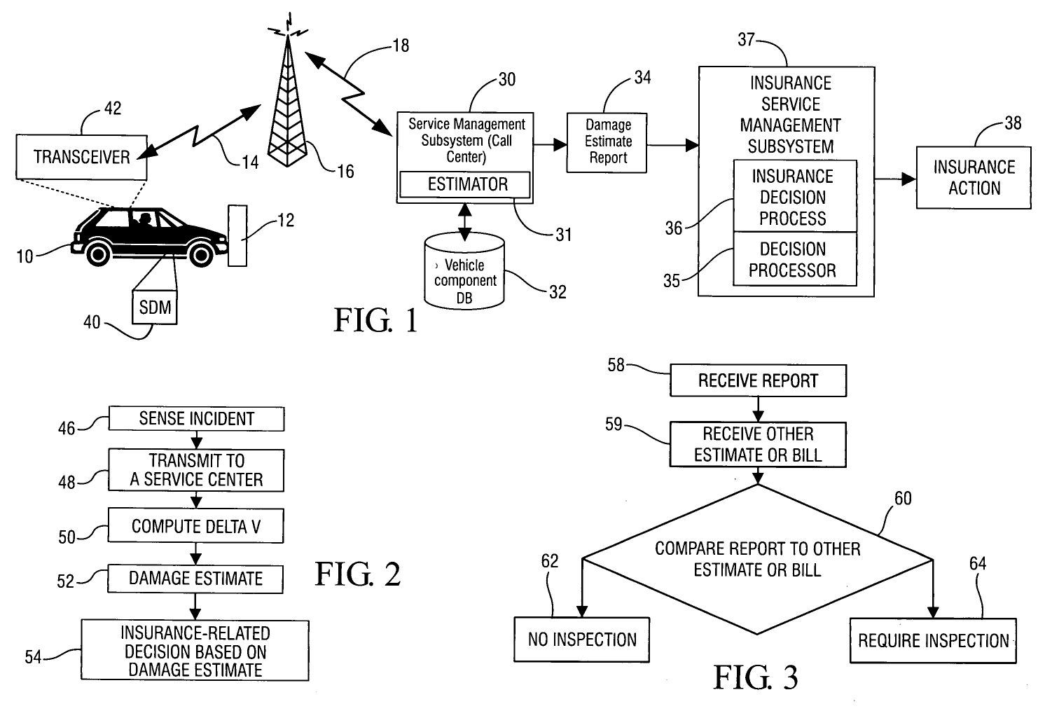

Referring now to FIG. 1, the example system includes a vehicle 10 with an on-board module 40 capable of sensing a vehicle incident such as a vehicle impact to object 12. The object 12 may be a fixed object or a moving object such as another vehicle. In addition to sensing vehicle impact to object 12, the module 40 may be capable of sensing other types of vehicle incidents, such as loss of four-wheel contact with the ground, body rotation and inversion.

The module 40 records data from one or more sensors during the incident. Example types of on-board modules 40 are well known, as are the functions of determining the occurrence of a vehicle incident, determining whether the incident is severe enough to trigger an on-board system such as SIR, and determining whether the incident is severe enough to trigger a call reporting the incident.

In one example, the data recorded by the module 40 represents accelerometer data and the module 40 converts the accelerometer data into a delta velocity. There are many techniques for determining delta velocity well known to those skilled in the art and they need not be set forth in detail herein. In alternative embodiments, delta velocity is determined at a service center from data transmitted by the transceiver 42, or delta velocity is determined by the transceiver 42 from data sent to it by module 40.

The module 42 receives either the recorded data, calculated value such as delta velocity or both from the module 40 and transmits either the recorded data, calculated value(s) such as delta velocity or both to the service center 30. References 14, 16 and 18 represent the transmission of data over a public communications network, such as a wireless mobile phone system or data network. The decision to transmit is performed automatically by the module 40 (or could be programmed into another module) and the outbound transmission is automatically initiated in response to the decision to transmit data.

The data transmission contains enough information to allow the service center 30 to automatically identify the vehicle and the service subscriber. Thus, for example, upon receipt of the transmission, the service center has or can develop through interactive database look-up, a record identifying the subscriber who owns the vehicle and the kind of vehicle in addition to the incident information. This process of utilizing identification data to obtain the user and vehicle identification is well known to those skilled in the art.

The service center 30 contains an estimator 31, which represents a computerized process that receives the data from the module 40, either in the form of recorded data or computed delta velocity, and utilizes this data along with the vehicle type information to determine an estimated damage value. The determination may be in the form of a database 32 look up in which the inputs are delta velocity and vehicle model and the output is an estimated damage. The estimated damage represents a range of actual damage values consistent with the data recorded by module 40. Additional database inputs may be utilized if the system designer desires. And, if direction is us utilized with the delta velocity magnitude, an estimated list of parts needing replacement can also be generated.

A suitable database 32 can be constructed by one skilled in the art using information tables available to the insurance industry or can be constructed utilizing vehicle OEM information on vehicle impact tests together with information of the type commonly used to estimate vehicle repairs.

The output of estimator 31 is a damage estimate report 34. The damage estimate report need not take any particular form. In a simple example, the damage report includes a range of valid repair estimates consistent with the delta velocity and or other data transmitted from the vehicle during the incident. A small delta velocity will correspond to limited vehicle damage and progressively larger delta velocities correspond to progressively more vehicle damage.

The damage estimate report 34 is transmitted, preferably in electronic format, to the insurance service management subsystem 37, which is part of the method for insuring the vehicle. The insurance service management subsystem 37 includes an insurance decision process 36 with a decision processor 35 for making an insurance-related decision and resulting action 38 based upon the damage estimate.

It is understood that the insurance service management subsystem 37, decision process 36 and decision processor 35 include computerized claim processing systems of a type known to those skilled in the art. The systems are modified according to this invention to include the ability to receive the damage estimate report 34 and incorporate that information into the corresponding customer records in the customer records database. In addition, automated decision processes and workflow management systems are modified to incorporate the decision processor 35 and resultant action 38. Such modifications are well with the scope of one skilled in the art in view of the teachings herein.

The insurance related action 38 may be any suitable business event that the insurance carrier deems appropriate in response to the damage estimate report 34. An example decision from processor 35 and action 38 is verifying the claim when received from the insurance customer by comparing the claimed repair value by the insurance customer with the damage estimate report 34. If the damage estimate report 34 and the claimed repair value from the customer are consistent, the resulting action 38 is that the insurance company can process the claim without requiring further inspections or verifications. And if the damage estimate report 34 is not consistent with the claimed repair value, then the action 38 is that the insurance company takes further steps to verify the customer's claim, such as requiring a field inspection of the vehicle 10 or requiring additional verification from other sources, such as police reports and witnesses.

Another example action 38 is immediately dispatching an inspector for prompt vehicle inspection in the event the damage estimate report 34 indicates a large damage estimate. An immediate inspection may help preserve data and also may help the insurance company more efficiently meet the needs of the customer.

Referring now to FIGS. 2 and 3, block 46 represents the step of sensing a vehicle incident in a vehicle body module 40 and block 48 represents the step of transmitting the data to a service center 30. Block 50 represents the step of computing vehicle delta velocity, which as indicated above may be done in one of the vehicle modules or at the service center 30 or 37. Block 52 represents the step of estimating the vehicle damage, for example, as described above with respect to the estimator 31 and block 54 represents the step of making an insurance-related decision based upon the damage estimate report 34.

Blocks 58 and 59 represent the steps of receiving the damage estimate report 34 and another damage estimate, such as a customer repair claim, independent repair shop quote, etc.. At block 60, the decision processor 35 compares the damage estimate report with the other damage estimate and provides the decision outputs 62 and 64 in response to the comparison. If the damage estimate report 34 is consistent with the other damage estimate received at step 59, then step 62 indicates that the claim can be further processed without an insurance adjuster inspection or without further confirmation. If the damage estimate report 34 is not consistent with the estimate or repair bill received at step 59, then step 64 indicates that the claim cannot be processed further until the claim is verified by inspection or other means, such as police report and witness corroboration.

The above example shows the estimator 31 and database 32 as part of service center 30. It will be evident to those skilled in the art that these functions can be implemented instead within the service center represented by the insurance service management subsystem 37 and that the data from the vehicle can be transmitted to the insurance service management subsystem 37 either directly or indirectly by way of service center 30.

1. A method for estimating vehicle damage comprising the steps of:
sensing a vehicle incident;
automatically sending vehicle incident data to a service center;
using the incident data to automatically estimate a vehicle damage; and
utilizing the estimated vehicle damage in a vehicle insurance decision process.

2. A method for estimating vehicle damage comprising the steps of:
sensing a vehicle incident;
obtaining an incident delta velocity from the vehicle incident;
sending the incident delta velocity to a service center;
at the service center, using the incident delta velocity with vehicle identification information to automatically estimate a vehicle damage value;
receiving a claim damage estimate;
comparing the automatically estimated vehicle damage value to the claim damage estimate; and
in response to the comparison, making an insurance claim-processing related decision.

3. The method of claim 2, wherein the step of making an insurance claim-processing related decision includes requiring an insurance inspection if the automatically estimated vehicle damage value differs by more than a predetermined amount from the claim damage estimate.

4. The method of claim 2, wherein the step of making an insurance claim-processing related decision includes omitting an insurance inspection if the automatically estimated vehicle damage value is consistent with the claim damage estimate.

5. A system for estimating vehicle damage comprising:
a module sensing an occurrence of a vehicle incident and developing incident data responsive thereto;
an in-vehicle transceiver for automatically sending vehicle incident data to a service center;
an estimator within the service center using the incident data to automatically estimate a vehicle damage value; and
a decision processor providing a business recommendation responsive to the estimated vehicle damage value.

6. The system of claim 5, wherein the decision processor provides a recommendation to require further verification of a vehicle insurance claim if the vehicle insurance claim is not consistent with the estimated vehicle damage report.

7. The system of claim 5, wherein the decision processor provides a recommendation to process a vehicle insurance claim without an insurance inspection if the vehicle insurance claim is consistent with the estimated vehicle damage report.
